(19) United States
(12) Patent Application Publication
(10) Pub. No.: US 2013/0036066 A1
(43) Pub. Date: Feb. 7, 2013

(54) SYSTEMS, METHODS, AND COMPUTER PROGRAM PRODUCTS FOR ONLINE CAREER NETWORKING

(71) Applicant: Goitom Telahun, Woodbridge, VA (US)

(72) Inventor: Goitom Telahun, Woodbridge, VA (US)

(21) Appl. No.: 13/650,360

(22) Filed: Oct. 12, 2012

Related U.S. Application Data
(63) Continuation-in-part of application No. 12/731,493, filed on Mar. 25, 2010.
(60) Provisional application No. 61/164,243, filed on Mar. 27, 2009.

(51) Int. Cl. G06Q 10/06

(52) U.S. Cl. 705/321

(57) ABSTRACT

A method and computer program product for career networking is provided. A career networking apparatus may receive a request to create a job opening and associate it with a desired level of competency, job hierarchy, prerequisite, and organization profile. A method for searching for and displaying a job opening is also provided. An applicant may create a profile and assign different levels of privacy to profile information. Profiles may be viewed by recruiters according to profile privacy levels and clearance levels of the recruiter.

### CROSS REFERENCE TO RELATED APPLICATIONS

This patent application is a continuation-in-part of, and claims priority to, U.S. Non-Provisional patent application Ser. No. 12/731,493, filed Mar. 25, 2010, entitled “Systems and Methods for Online Career Content and Networking,” which claims priority from U.S. Provisional Application No. 61/164,243, filed Mar. 27, 2009, entitled “Systems and Methods for Online Career Content and Networking,” both of which are hereby incorporated by reference in their entireties.

### TECHNOLOGICAL FIELD

Example embodiments of the present invention relate generally to computer technology and, more particularly, relate to methods, apparatuses, and computer program products for online career networking.

### BACKGROUND

The widespread use of the Internet for recruiting employees and finding jobs has led to a demand for improved career networking systems. The number of job openings posted to online career sites and the increasing volume of applicants searching and applying for jobs online make it difficult for employers to find qualified applicants. Additionally, it can be difficult for applicants to find jobs for which they are qualified that are consistent with their career goals.

### BRIEF SUMMARY

Current career websites may lack the sophistication desired by job applicants and, therefore, may require applicants to sift through irrelevant or inappropriate job openings in order to identify suitable opportunities. Additionally, some applicants may not have a clear path or objectives for their career and, thus, may not know what to search for on a career website. Similarly, employers may have difficulty posting job openings that will adequately attract ideal applicants, thereby forcing them to filter through numerous applications from unsuitable applicants in order to identify qualified applicants. Along these lines, an applicant may not know what potential job opportunities that they are qualified for.

Methods, apparatuses, and computer program products are provided herein for a more efficient process for creating and/or locating job openings provided for online career networking. In an example embodiment, a method is provided comprising receiving a request to create a job opening. The method further comprises receiving an indication of a job type and an indication of a desired level of competency of a desired applicant applying for the job opening. The desired level of competency of the desired applicant comprises at least one of the following: the desired applicant has performed the job type before, the desired applicant has a skill-set used in the job type, or the desired applicant is able to learn the job type. The method further comprises associating, by a processor, the job type and the desired level of competency of the desired applicant with the job opening.

In some embodiments, the indication of the desired level of competency comprises a selection of at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type.

In some embodiments, the method may further comprise receiving a request to display the job opening and causing display of the job opening in response to receiving the request to display the job opening, wherein causing display of the job opening comprises causing display of the job type and the desired level of competency associated with the job opening.

In some embodiments, the method may further comprise receiving an indication of a job hierarchy to be associated with the job opening, wherein the job hierarchy comprises at least one of a job universe, a job roof, and a job room, and associating the job hierarchy with the job opening.

In some embodiments, the method may further comprise defining at least one job code portion, wherein each job code portion relates to a characteristic of the job opening, defining a standardized job code comprising at least one job code portion, and associating the standardized job code with the job opening.

In some embodiments, the method may further comprise receiving an indication of at least one prerequisite relating to the job opening, wherein the at least one prerequisite comprises at least one of a certification, qualification, or designation of the desired applicant, and associating the at least one prerequisite with the job opening.

In some embodiments, the method may further comprise receiving an organization profile relating to the job opening and associating the organization profile with the job opening.

In another example embodiment, a computer program product is provided comprising a non-transitory computer readable medium having program code portions stored thereon, the program code portions being a computer readable medium, configured when said program product is run on a computer or network device to receive a request to create a job opening. The at least one memory and stored computer program code are configured, with the at least one processor, to further cause the apparatus to receive an indication of a job type and an indication of a desired level of competency of a desired applicant applying for the job opening. The desired level of competency of the desired applicant comprises at least one of the following: the desired applicant has performed the job type before, the desired applicant has a skill-set used in the job type, or the desired applicant is able to learn the job type. The at least one memory and stored computer program code are configured, with the at least one processor, to further cause the apparatus to associate the job type and the desired level of competency of the desired applicant with the job opening.

In some embodiments, the indication of the desired level of competency comprises a selection of at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type.

In another example embodiment, a method is provided comprising receiving a request from an applicant to display at least one job opening associated with a job type. The method further comprises determining, by a processor, an applicant level of competency for the job type. The applicant level of competency for the job type may comprise at least one of the following: the applicant has performed the job type before, the applicant has a skill-set used in the job type, or the applicant is able to learn the job type. The method further comprises performing a query to locate at least one job opening associated with the job type and a desired level of competency satisfied by the applicant level of competency. The method further comprises causing display of the at least one located job opening.

In some embodiments, the desired level of competency comprises at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type.

In some embodiments, the method may further comprise determining a desired job hierarchy for the applicant including at least one of a job universe, a job roof, and a job room, and wherein the at least one job opening satisfies the desired job hierarchy.

In some embodiments, the method may further comprise determining at least one certification, qualification, or designation of the applicant, wherein a prerequisite of the at least one located job opening is satisfied by the at least one certification, qualification, or designation of the applicant.

In some embodiments, the method may further comprise determining a preferred organization for an applicant, wherein the preferred organization for the applicant is satisfied by the organization associated with the at least one located job.

In some embodiments, the method may further comprise determining, based at least in part on the job type of the job opening, at least one additional job type and causing display of the at least one additional job type.

In another example embodiment, a computer program product comprising a non-transitory computer readable medium having program code portions stored thereon, the program code portions being a computer readable medium, configured when said program product is run on a computer or network device, to receive a request from an applicant to display at least one job opening associated with a job type. The at least one memory and stored computer program code are configured, with the at least one processor, to further cause the apparatus to determine an applicant level of competency for the job type. The applicant level of competency for the job type comprises at least one of the following: the applicant has performed the job type before, the applicant has a skill-set used in the job type, or the applicant is able to learn the job type. The at least one memory and stored computer program code are configured, with the at least one processor, to further cause the apparatus to query job openings to locate at least one job opening associated with the job type, wherein the applicant level of competency satisfies a desired level of competency associated with the job opening. The at least one memory and stored computer program code are configured, with the at least one processor, to further cause the apparatus to cause display of the at least one located job opening.

In some embodiments, the desired level of competency comprises at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type.

In another example embodiment, a method is provided comprising receiving a request from an applicant to create an applicant profile. The method further comprises receiving from the applicant at least one set of applicant data to be associated with the applicant profile. The method further comprises receiving an indication of a level of privacy for each set of applicant data, wherein the indication of the level of privacy comprises a selection of one of a first privacy level, a second privacy level, or a third privacy level. The method further comprises associating, by a processor, each set of applicant data with the indicated level of privacy and receiving a request from a recruiter to display applicant data. The method further comprises determining a privacy clearance associated with the request, wherein the privacy clearance comprises one of a first clearance level, a second clearance level, and a third clearance level. The method further comprises causing display of applicant data associated with the level of privacy satisfied by the privacy clearance, wherein the first privacy level is satisfied by the first clearance level, second clearance level, and third clearance level, wherein the second privacy level is satisfied by the second clearance level and third clearance level, and wherein the third privacy level is satisfied by the third clearance level.

In some embodiments, the method may further comprise determining the privacy clearance by determining a job interview status associated with the request of the recruiter, wherein the job interview status comprises one of a first interview level, a second interview level, and a third interview level, and wherein the first interview level is associated with the first clearance level, the second interview level is associated with the second clearance level, and the third interview level is associated with the third clearance level.

In some embodiments, the method may further comprise receiving an indication of an active job type list comprising job types the applicant is actively seeking, receiving an indication of a passive job type list comprising job types the applicant is passively seeking, and associating the active job type list and passive job type list to the applicant profile.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a system for online career networking according to some example embodiments described herein;

FIG. 2 illustrates a block diagram of a career networking apparatus in accordance with some example embodiments described herein;

FIG. 3 illustrates an example display for selecting a career type, according to some example embodiments described herein;

FIG. 4 illustrates an example display of a job hierarchy for a call center from the perspective of a recruiter, according to some example embodiments described herein;

FIG. 5 illustrates an example display of a job hierarchy for a call center from the perspective of a recruiter and/or applicant, according to an example embodiment described herein;

FIG. 5A illustrates an example job code portion for the number of employees a specific position may require management of, according to some example embodiments described herein;

FIG. 5B illustrates a number of example job code portions for different characteristics of a job, according to some example embodiments described herein;

FIGS. 6-13 illustrate example displays that enable a recruiter to create a job posting, according to some example embodiments described herein;

FIG. 14 illustrates an example display of a job hierarchy for a call center from the perspective of a recruiter, wherein navigation features are provided, according to some example embodiments described herein;

FIG. 15 illustrates an example display of a job hierarchy for a call center from the perspective of a recruiter, wherein filtering features are provided, according to some example embodiments described herein;

FIG. 16 illustrates an example display of a job hierarchy for a call center from the perspective of an applicant, wherein features for job type information are provided, according to some example embodiments described herein;

FIG. 17 illustrates an example display of a job hierarchy for a call center and corresponding links to more information, from the perspective of an applicant, according to some example embodiments described herein;

FIG. 17A illustrates another example display of a job hierarchy for a call center from the perspective of an applicant, according to some example embodiments described herein

FIG. 18 illustrates an example palette or portion of a user profile, according to some example embodiments described herein;

FIG. 19 is a flowchart illustrating an example method for creating a job opening, according to some example embodiments described herein;

FIG. 20 is a flowchart illustrating an example method for searching for and displaying a job opening, according to some example embodiments described herein; and

FIG. 21 is a flowchart illustrating an example method for creating an applicant profile, according to some example embodiments described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable storage media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As used herein, where a computing device is described herein to receive data from another computing device, it will be appreciated that the data may be received directly from the another computing device and/or may be received indirectly via one or more intermediary computing devices, such as, for example, one or more servers, relays, routers, network access points, and/or the like. Similarly, where a computing device is described herein to send data to another computing device, it will be appreciated that the data may be sent directly to the another computing device or may be sent to another computing device via one or more interlinking computing devices, such as, for example, one or more servers, relays, routers, network access points, and/or the like.

Additionally, as used herein, although the figures and examples may refer to users such as recruiters and applicants, other types of users are contemplated (e.g., executives, employers, educators, employees, entrepreneurs, contractors, consultants, etc.). Indeed, example embodiments of the present invention may be used with any type of user.

FIG. 1 illustrates a system 101 for online career networking according to some example embodiments. It will be appreciated that the system 101 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for online career networking, numerous other configurations may also be used to implement embodiments of the present invention.

The system 101 may include a career networking apparatus 102 that may be configured to provide career networking functionality to any number of user terminals 110, which may, for example, be embodied as a laptop computer, tablet computer, mobile phone, desktop computer, workstation, or other like computing device. In some embodiments, a user terminal 110 may be remote from the career networking apparatus 102, in which case the user terminal 110 may communicate with career networking apparatus 102 remotely, such as via network 100. Additionally or alternatively, the user terminal 110 may be implemented on the career networking apparatus 102 or may be directly connected to career networking apparatus 102.

Career networking apparatus 102 may be configured to communicate with user terminal 110 via any of a variety of methods dependent upon the configuration of the system 101. For example, in embodiments in which a career networking apparatus 102 is disposed remotely from the user terminal 110, communication via the network 100 may occur by a variety of connections. The network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, a wireless wide area network, some combination thereof, or the like), or a combination thereof, and in some example embodiments comprises at least a portion of the Internet.

In some example embodiments, the career networking apparatus 102 may be embodied as or comprise one or more computing devices, such as, by way of non-limiting example, one or more servers configured to access the network 100. In some example embodiments, the career networking apparatus 102 may be implemented as a distributed system or a cloud-based entity that may be implemented within the network 100. In this regard, the career networking apparatus 102 may comprise one or more servers, a server cluster, one or more network nodes, a cloud computing infrastructure, some combination thereof, or the like.

FIG. 2 illustrates a career networking apparatus 102 in further detail, in accordance with some example embodiments. However, it should be noted that the components, devices, and elements illustrated in and described with respect to FIG. 2 may not be mandatory and, thus, on or more of the components, devices, or elements illustrated may be omitted in certain embodiments. Additionally, some embodiments may include further or different components, devices, or elements beyond those illustrated in and described with respect to FIG. 2.

Continuing with FIG. 2, processing circuitry 210 may be provided that is configured to perform actions in accordance with one or more example embodiments disclosed herein. In this regard, the processing circuitry 210 may be configured to perform and/or control performance of one or more functionalities of the career networking apparatus 102 in accordance with various example embodiments. The processing circuitry 210 may be configured to perform data processing, application execution, and/or other processing and management services according to one or more example embodiments. In some embodiments, the career networking apparatus 102 or a portion(s) or component(s) thereof, such as the processing circuitry 210, may be embodied as or comprise a circuit chip. The circuit chip may be configured to perform one or more operations for providing the functionalities described herein.

In some example embodiments, the processing circuitry 210 may include a processor 212 and, in some embodiments such as that illustrated in FIG. 2, may further include memory 214. The processing circuitry 210 may be in communication with or otherwise control any number of components or controllers configured to perform various operations consistent with some embodiments of the present invention. For example, with reference to FIG. 2, the processing circuitry 210 may be in communication with or otherwise control (e.g., via the processor 212) a user interface 216, a job opening controller 220, profile controller 230, search controller 240 and/or a communication interface 218. In some embodiments, the processing circuitry 210 may be embodied as a circuit chip (e.g., an integrated circuit chip) configured (e.g., with hardware, software, or a combination of hardware and software) to perform operations described herein. Along these lines, though the illustrated example embodiment of FIG. 2 details a number of different controllers and/or components in communication with or otherwise controlled by the processing circuitry 210, in some embodiments the processing circuitry 210 may be configured to directly control any operation described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of the career networking apparatus 102 as described herein. The plurality of processors may be embodied on a single computing device or distributed across a plurality of computing devices collectively configured to function as the career networking apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry in the form of processing circuitry 210) capable of performing operations according to embodiments of the present invention while configured accordingly. Thus, for example, when the processor 212 is embodied as an ASIC, FPGA, or the like, the processor 212 may comprise hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the career networking apparatus 102. The memory 214 may be configured to store information, data, applications, instructions and/or the like for enabling the career networking apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 216, communication interface 218, job opening controller 220, profile controller 230, and search controller 240 for passing information among components of career networking apparatus 102.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, provide means for user control of career networking operations and/or the like. In some example embodiments in which the career networking apparatus 102 is embodied as a server, cloud computing system, or the like, aspects of the user interface 216 may be limited or the user interface 216 may not be present. In some example embodiments, one or more aspects of the user interface 216 may be implemented on a user terminal 110. Accordingly, regardless of implementation, the user interface 216 may provide input and output means to facilitate career networking in accordance with one or more example embodiments.

The communication interface 218 may include one or more interface mechanisms for enabling communication with other devices and/or networks. In some cases, the communication interface 218 may be any means such as a device or circuitry embodied in either hardware or a combination of hardware and software that is configured to receive and/or transmit data from/to a network and/or any other device or module in communication with the processing circuitry 210. By way of example, the communication interface 218 may be configured to enable the career networking apparatus 102 to communicate with the user terminal 110 via the network 100. Accordingly, the communication interface 218 may, for example, include supporting hardware and/or software for enabling communications via cable, digital subscriber line (DSL), universal serial bus (USB), Ethernet, or other methods.

In some example embodiments, the processor 212 (or the processing circuitry 210) may be embodied as, include, or otherwise control a job opening controller 220, profile controller 230, and/or search controller 240. As such, the job opening controller 220, profile controller 230, and/or search controller 240 may be embodied as various means, such as circuitry, hardware, a computer program product comprising computer readable program instructions stored on a computer readable medium (for example, the memory 214) and executed by a processing device (for example, the processor 212), or some combination thereof. The job opening controller 220, profile controller 230, and/or search controller 240 may be implemented on separate apparatuses, the same apparatus, or any combination of apparatuses. The job opening controller 220, profile controller 230, and/or search controller 240 may be capable of communication with one or more of the processor 212, memory 214, user interface 216, and communication interface 218 to access, receive, and/or send data as may be needed to perform one or more of the functionalities described herein.

The career networking apparatus 102 may comprise a job opening database 224, and/or an applicant profile database 232. Additionally or alternatively, data described herein as being stored on the job open database 224 and/or the applicant profile database 232 may be stored on the memory 214. The job opening controller 220 may communicate with the job opening database 224 to maintain job opening details. The profile controller 230 may communicate with the applicant profile database 232 to maintain profile related data. The search controller 240 may query the job opening database 224 and/or the applicant profile database 232 to enable career networking and/or searching functionalities described herein. In some example embodiments, such as those in which the career networking apparatus 102 is implemented as a distributed system, the job opening database 224 and/or the applicant profile database 232 may be remote from other components of the career networking apparatus 102, and may be accessed by job opening controller 220 and the profile controller 230, respectively, via the communication interface 218.

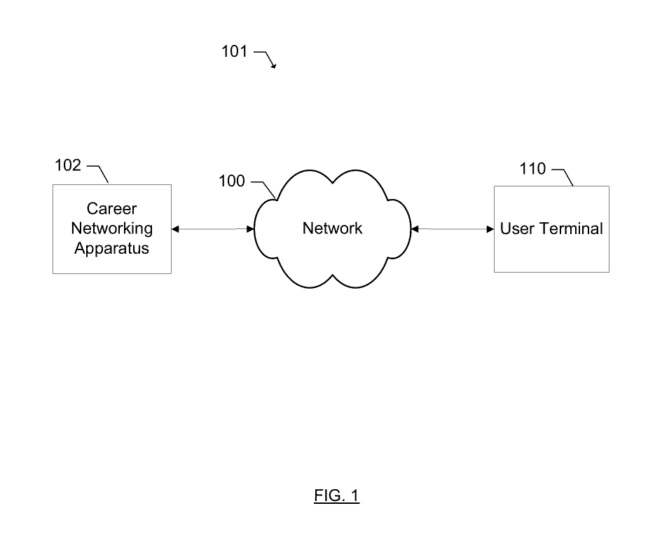

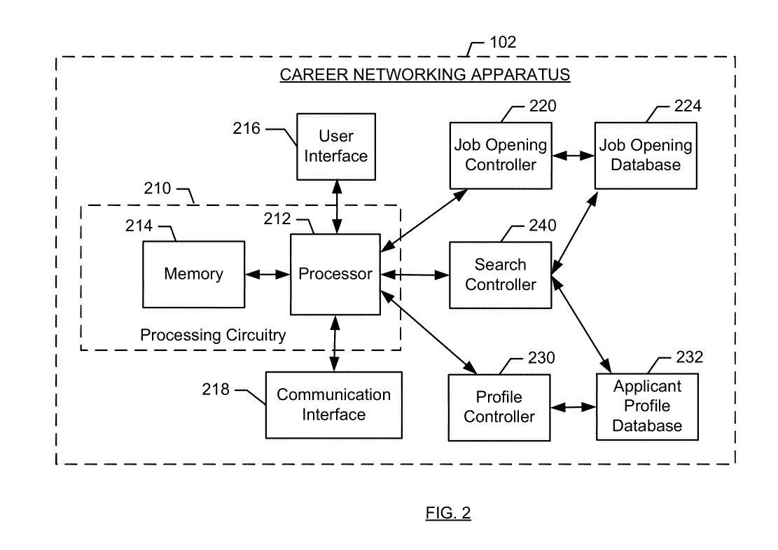

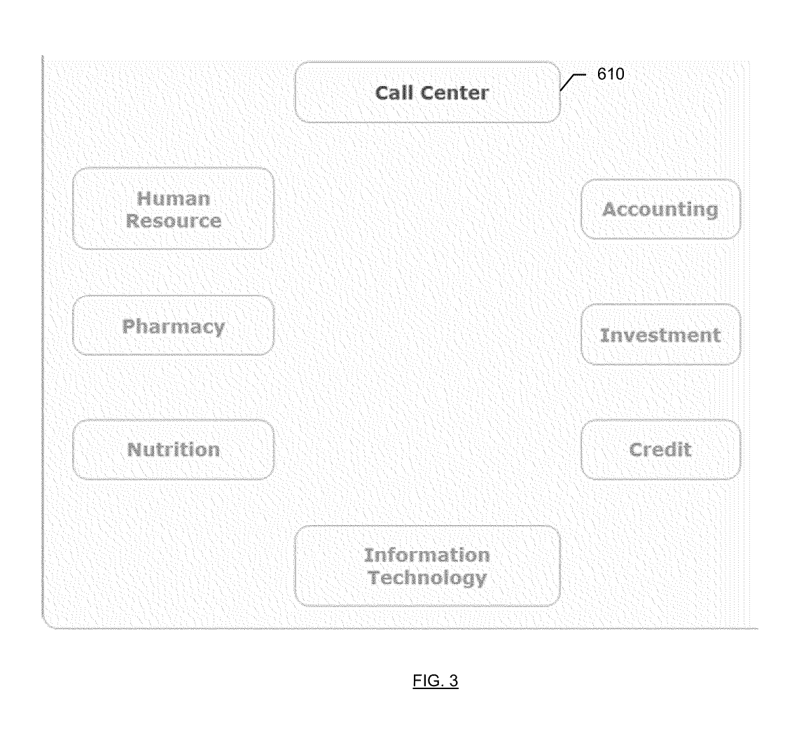

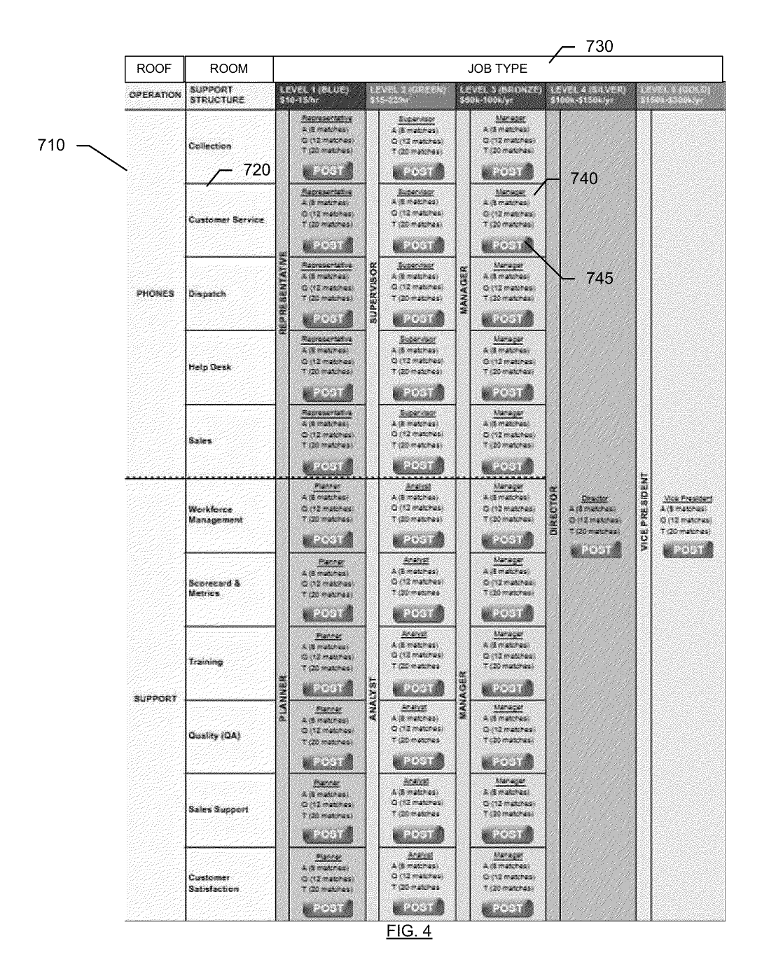

In some embodiments, the career networking apparatus 102 may be configured to provide a visual display presenting possible careers for an applicant, such as illustrated in FIG. 3. FIG. 3 may illustrate, such as on user terminal 110) an example display of possible careers for an applicant, such as may be useful for an applicant to learn about a career. In the example depicted in FIG. 3, a user has indicated at 610 a job universe of a call center. In this regard, a job universe may be characterized as an industry focused category. In some embodiments, as will be described in greater detail herein, a display such as the one illustrated in FIG. 3 may be used by an applicant searching for a job and/or indicating an active and/or passive job type to associate with an applicant profile. Additionally or alternatively, the display of FIG. 3 may be used by a recruiter assigning a job type to a job posting. Upon selection of a job universe, such as job universe 610, a user may be able to access additional information regarding the job universe, including but not limited to, a display such as the display of FIG. 4.

In some embodiments, the career networking apparatus 102 may be configured to display job openings by hierarchy, such as in the example display of FIG. 4. In this regard, a hierarchy may be characterized as an ordered listing of job universe, job roof, and job room. In the depicted embodiment, the job universe is the call center (e.g., the industry), the job roof may be either phones or support (e.g., a sector within the industry), and the job room is each specific department within the sector of the industry (e.g., help desk, customer service, etc.) FIG. 4 is an example display a recruiter may use to navigate existing job openings by job hierarchy, and to initiate adding a job opening by job hierarchy. A similar view may be provided to an applicant. As such, organizing the job openings in a hierarchy of universe, roof, and room, may help an applicant find closely related jobs, say in the same universe, but in a different room, that the applicant may not have otherwise known about. For example, a job opening may be associated with a job universe of call center, a job roof of phones, and a job room of help desk. In this regard, a job opening is related to the job environment of a call center, more specifically involves work relating directly to making or taking phone calls, and even more specifically is associated with working in a help desk group. It will be appreciated that the job universe, job roof, and/or job room hierarchy is provided as an example and that a job hierarchy may comprise any number and any type of categories for classifying a job opening.

A display such as that of FIG. 4 may help a recruiter post a job in the correct career universe, roof, and/or room by enabling the recruiter to compare and contrast different job areas. In this example, a recruiter may have already indicated a job universe, such as call center. In area 710, the career networking apparatus 102 may provide a job roof(s) that is a part of the call center universe, such as phones or support. In area 720, a job room, such as customer service, may be displayed that is associated with the corresponding job roof, phones. Columns such as those under job type area 730 may provide a space for display of different job levels (e.g., representative, supervisor, manager, vice president, etc.). As will be described in greater detail herein, the job opening summary 740 may list the number of job openings currently posted by desired level of competency, such as ‘A’ (representing acquired), ‘Q’ (representing qualified), and/or ‘T’ (representing targeted). For example, in area 740, the job opening summary corresponding to a manager posting in customer service shows there are currently 10 job openings with a desired level of competency of acquired, 5 job openings with a desired level of competency of qualified, and 3 job openings with a desired level of competency of targeted. Additionally or alternatively, job opening summary 740 may display a button or link 745 to initiate adding a new posting in the respective job universe, roof, and room hierarchy. Upon selection of the “POST” button or link 745, the career networking apparatus 102 may receive an indication to create a job opening, as described in greater detail below.

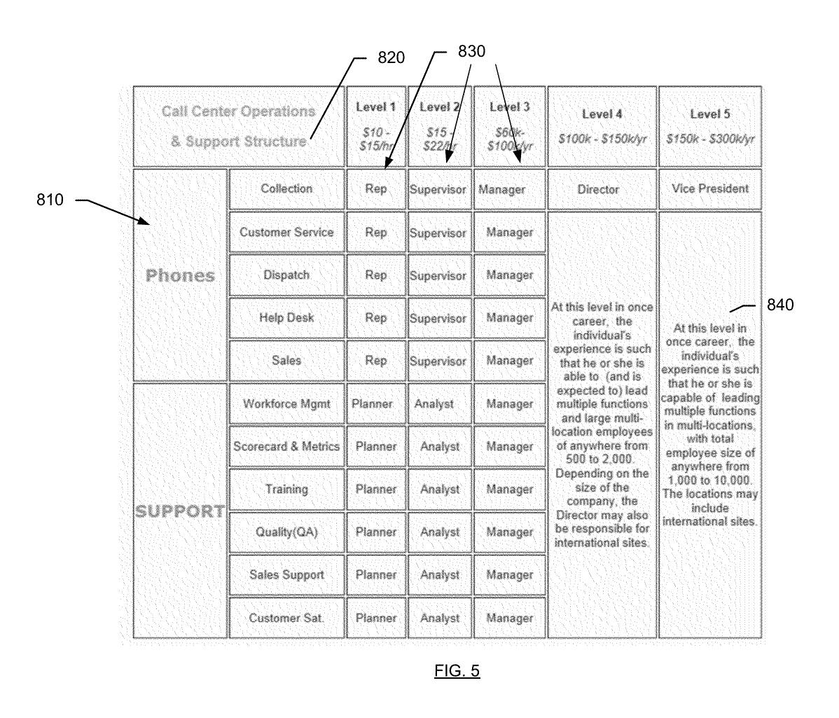

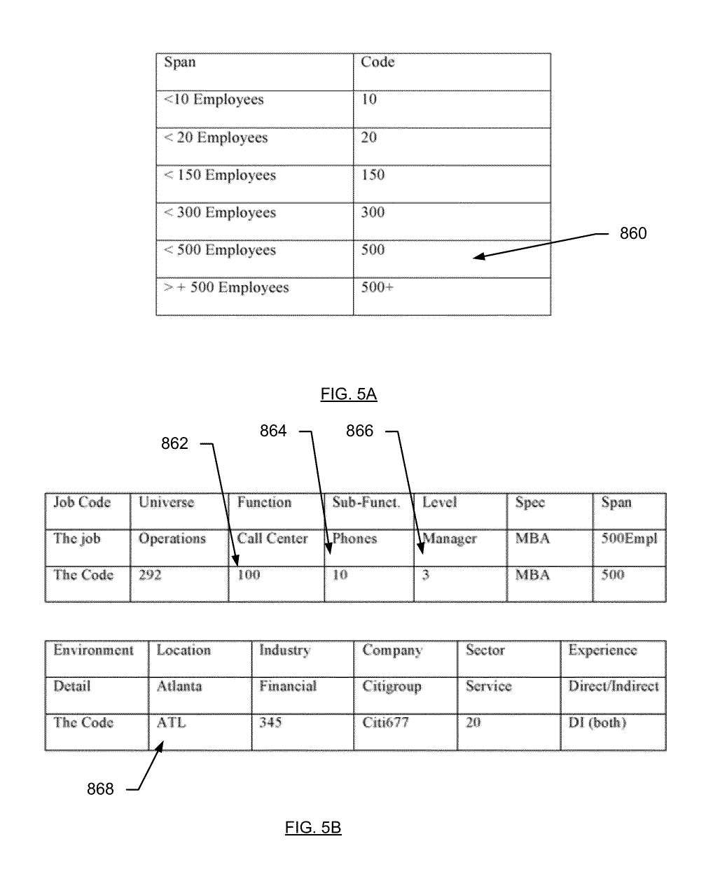

In some embodiments, a career networking apparatus 102 may be configured to display a career encyclopedia, such as shown in the example display of FIG. 5. A career encyclopedia may display example career paths for an applicant to view. FIG. 5 illustrates an example display that shows an educational view of a particular job universe in a job universe, roof, and room hierarchy. In this example, the call center universe is displayed, showing the job roofs of phones and support in area 810, and corresponding job rooms such as in area 820. Positions by job level associated with the corresponding job hierarchy may be displayed on the same row in area 830. In some embodiments, the position displayed may be or include a link to additional information about the job within the corresponding job hierarchy. Additionally or alternatively, area 830 may comprise a link to job openings in the corresponding job hierarchy. The display of FIG. 5 may comprise descriptions 840 of a position by level. In this regard, the display of FIG. 5 may be used by recruiters researching the hierarchy in which to add a job opening, or by applicants researching which job hierarchy they are interested in and/or are qualified for. In an instance where a recruiter uses the display to indicate a job hierarchy, the career networking apparatus 102 may receive an indication of a job hierarchy to be associated with the job opening. Indeed, in some embodiments, as will be described in greater detail herein, the career networking apparatus 102 may initiate a job opening creation program in response to the indication on the job hierarchy.

### Creating a Job Opening Posting

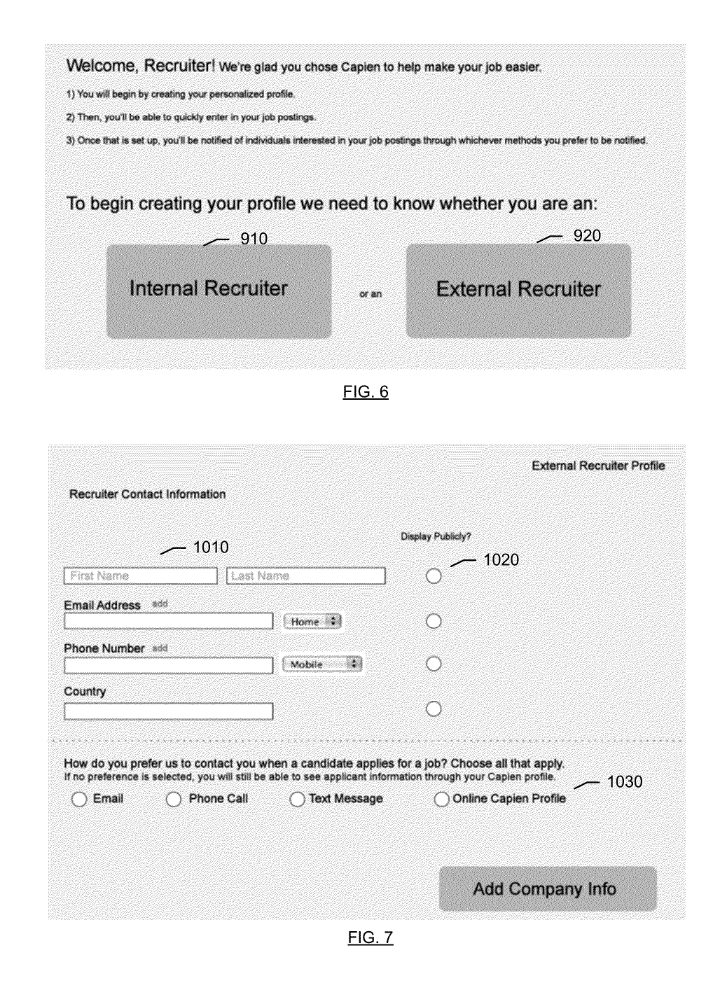

In some embodiments, the career networking apparatus 102 may be configured to create a job opening. FIGS. 6-13 illustrate example displays that may be presented to a user (e.g., a recruiter) to enable the recruiter to create a job opening, according to some example embodiments.

In some embodiments, the career networking apparatus 102 may be configured to receive a request to create a job opening. FIG. 6 is an example display that may be presented to a user by which the user (e.g., a recruiter) may initiate the job opening creation process. By selecting indicator 910, a user may indicate they are an internal recruiter, such as one employed by the company they are recruiting for. By selecting indicator 920, a user may indicate they are an external recruiter, such as an independently employed headhunter placing applicants with employers they do not work directly for.

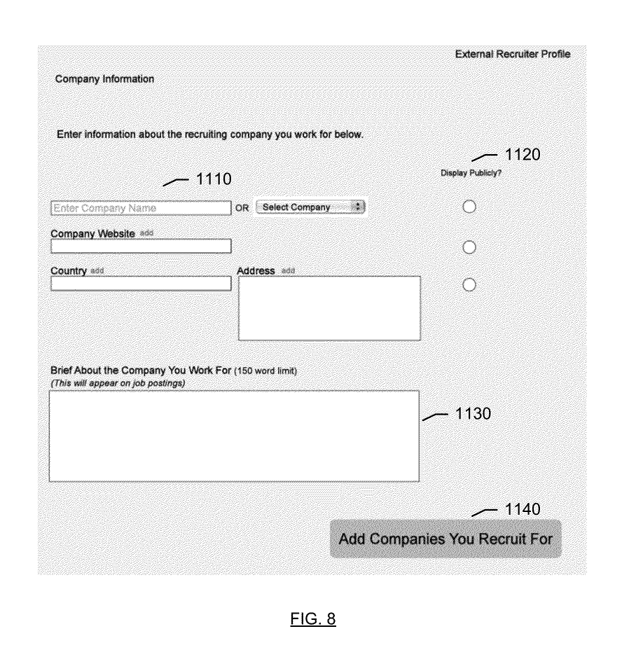

In some embodiments, upon receiving an indication to create a job opening (e.g., via the display of FIG. 6), the career networking apparatus 102 may present the display of FIG. 7 for a recruiter to continue providing recruiter information. In area 1010, a recruiter may provide personal information including but not limited to name, email address, phone number, and country. In area 1020, a recruiter may indicate, for each part of personal information, whether or not they would like the information to display publicly to users of the system (e.g., to other recruiters or applications). In area 1030, a recruiter may indicate a preferred method of communication by which to be contacted in the event an applicant applies for a job. Such options may include email, phone, text message, profile, and/or any other communication method.

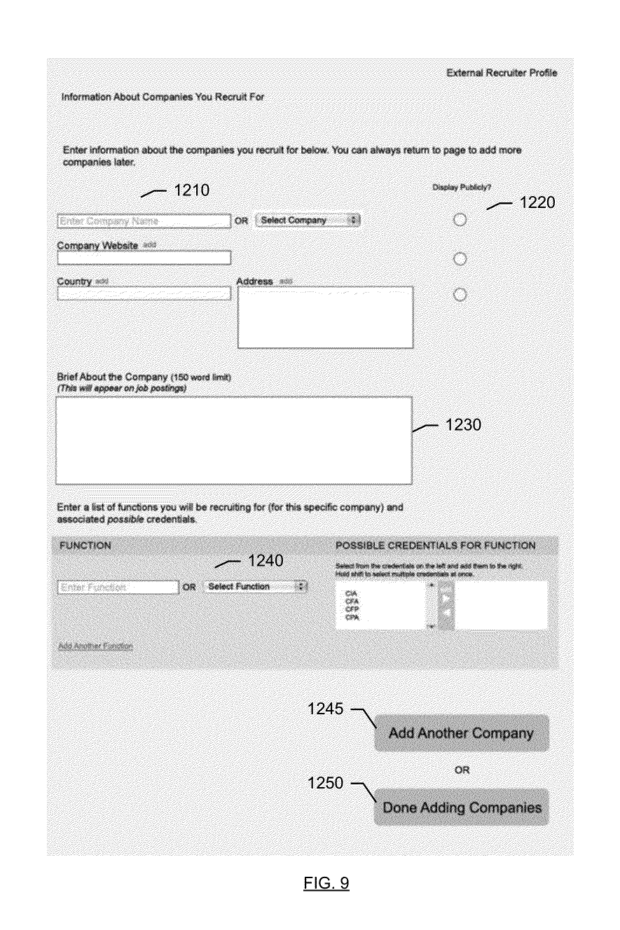

In some embodiments, the career networking apparatus 102 may be configured to receive an organization profile related to a job opening, such as by use of a display as depicted in FIG. 8. In this example, a recruiter has indicated they recruit for an external company (e.g., via the display of FIG. 6), and the display may thus be tailored for use by an external recruiter. In area 1110, the recruiter may provide company information such as company name, website, country, and/or address. In area 1120, the recruiter may indicate which fields may be displayed publicly to other users. In area 1130, a recruiter may provide additional information about the recruiting company that may be included in a job posting for applicants to see. In addition, by selecting a button 1140, the recruiter may indicate that they wish to add company information for other companies they recruit for. In response, job opening controller 22, or profile controller 230, may present a display such as that shown in FIG. 9.

Accordingly, in some embodiments, the career networking apparatus 102 may be configured to receive an organization profile related to a job opening, such as by use of a display such as the example display depicted in FIG. 9. FIG. 9 illustrates an example display for a recruiter to provide information about the company for which the recruiter is posting a job. In area 1210, a recruiter many enter company information for the company they recruit for, such as, but not limited to, company name, company website, country, and/or address. In area 1220, a recruiter may indicate which information may be displayed publicly to other users. Area 1230 may provide a space (e.g., a text box) for a recruiter to provide additional information about the company. In area 1240, a recruiter may provide functions (e.g., job types) the recruiter may recruit for, and corresponding credentials (e.g., licenses, bachelor degree, registrations, etc.) for each function. A recruiter may select a button 1245 to add another company and, in response, the job opening controller 220 and/or profile controller 230 may provide an additional display such as that of FIG. 9 to allow the recruiter to provide another company's information. Additionally or alternatively, a recruiter may select indicator 1250 to indicate that they are done adding company information.

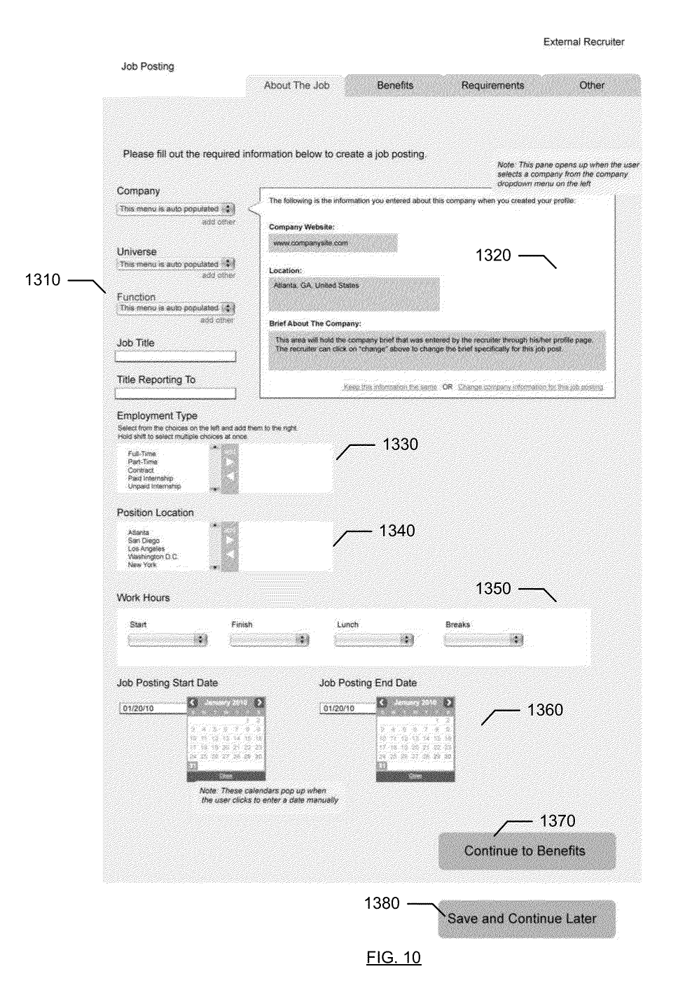

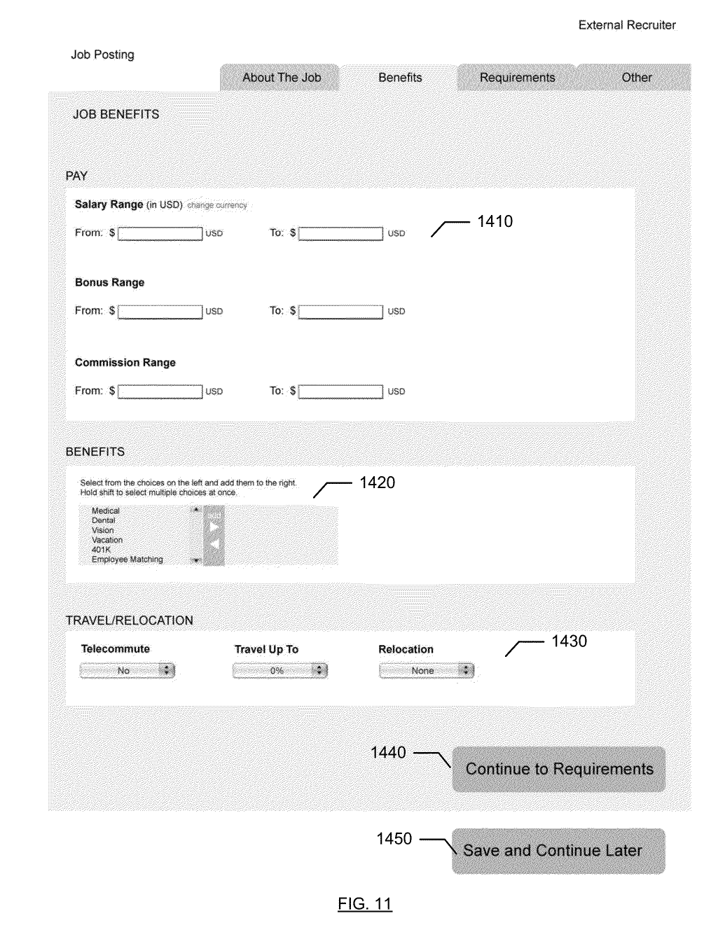

In some embodiments, the career networking apparatus 102 may be configured to receive job opening information to create a job posting. FIG. 10 is an example display that a recruiter may use to enter job opening information. In area 1310 a recruiter may provide job opening information, such as a company seeking an applicant to fill a position, that may be selected from a list of companies as previously entered (e.g., by a recruiter or other user via the display of FIG. 9 as described above). Upon selection of an existing company, area 1320 may automatically be populated with company details so the recruiter may verify the accuracy of the information. In some embodiments, career networking apparatus 102 may be configured to receive indication of a job hierarchy to associate with the job opening. Area 1310 may comprise selections of a job universe, job roof, job room, job title, and/or the title to which the job opening title reports. Area 1330 may allow the user to specify employment type, such as, but not limited to full-time, part-time, contract, paid internship, and/or unpaid internship. Area 1340 may provide for selection of a location for the job opening. The location may be selected from locations previously provided when providing company information. Area 1350 may allow for a recruiter to provide details regarding the work hours associated with the job opening, such as, but not limited to, a start time, end time, and break details. Area 1360 may provide for indication of a job posting start data and/or end date. In this regard, if a recruiter indicates a start and/or end date, the job posting may only be accessed and/or viewable by other users during the specified timeframe. A recruiter may select a button 1370 to continue to another screen for entering benefit information for the job opening, or they may select an indicator 1380 to save the information that has been entered and continue entering job opening information at a later time.

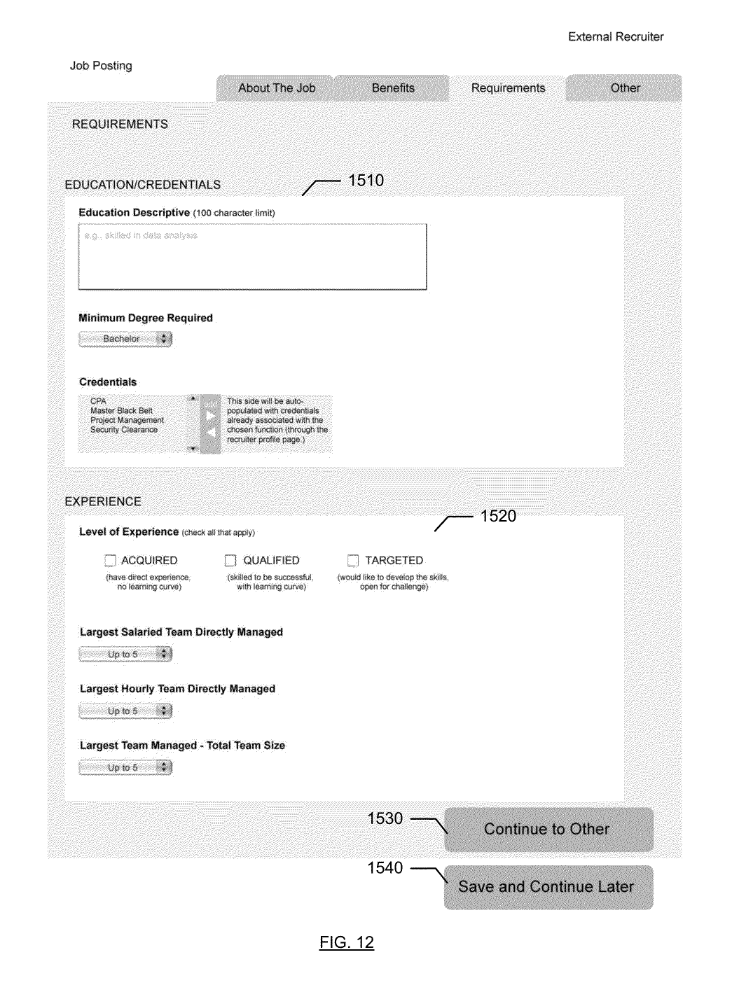

In some embodiments, the career networking apparatus 102 may be configured to receive benefit information to associate with a job opening. In an instance in which a recruiter has provided the initial job opening details, such as via the display of FIG. 10, a recruiter may continue to enter benefit information to associate with the job opening, in a display such as depicted in FIG. 11. In area 1410, for example, a recruiter may provide a salary range, bonus range, and/or commission range for the job opening. In area 1420, a recruiter may select from a list of benefits that will be made available to an employee hired for the job opening, such as medical benefits, 401k, pensions, etc. Area 1430 may be provided to allow the recruiter to indicate if telecommuting is available, a percentage of travel time, and whether or not compensation for relocation may be offered in association with the job opening. A recruiter may select indicator 1440 to continue entering requirements for the job opening, and/or may save and continue the data entry process later by selecting indicator 1450.

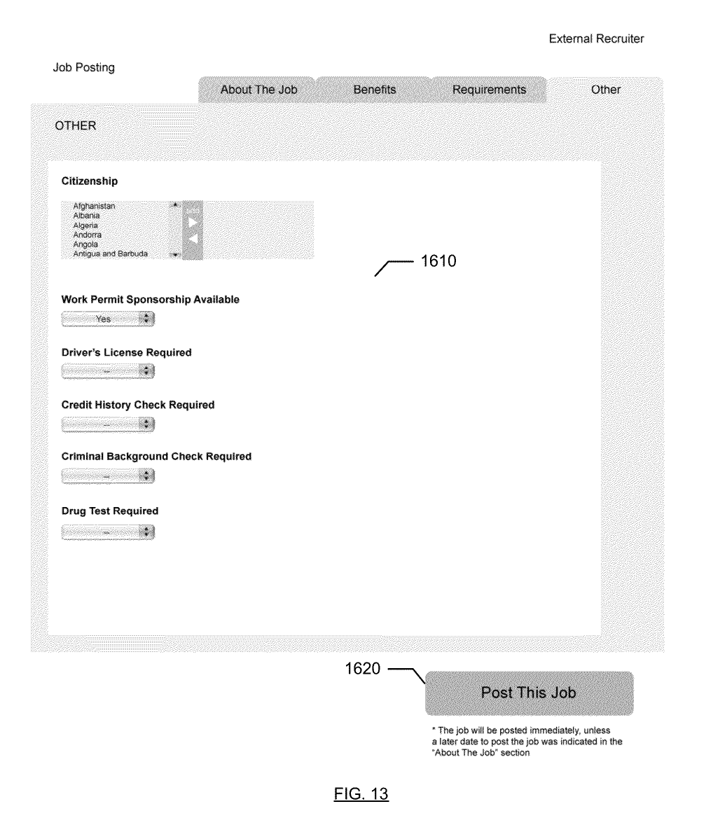

In some embodiments, career networking apparatus 102 may be configured to receive information regarding prerequisites to associate with the job opening (e.g., requirements that must be met by an applicant for a particular position). For example, FIG. 12 illustrates an example display that may be used by a recruiter to provide prerequisites for a job opening. Area 1510 may be provided to allow entry of education and credential prerequisites. As such, a description of a preferred education of an applicant may be entered, a minimum degree may be selected, and a list of prerequisites for the job opening (e.g., certifications or security clearances) may be selected.

In some embodiments, the career networking apparatus 102 may be configured to receive an indication of a desired level of competency to associate with the job opening. For example, with reference to FIG. 12, area 1520 may be provided to allow the recruiter to enter a desired experience level of an applicant. In some embodiments, the desired level of competency of the desired applicant comprises at least one of the following: the desired applicant has performed the job type before, the desired applicant has a skill-set used in the job type, or the desired applicant is able to learn the job type. Additionally or alternatively, in some embodiments, the desired level of competency comprises a selection of at least one of acquired, qualified, or targeted, where acquired relates to the desired applicant having performed the job type before, qualified relates to the desired applicant having the skill-set used in the job type, and targeted relates to the desired applicant being able to learn the job type. For example, as shown in FIG. 12, a desired level of competency, such as acquired, qualified, and/or targeted may be selected via check boxes. In such a manner, the recruiter may define the desired level of competency of a desired applicant for the job opening.

In some embodiments, other characteristics of the job opening may be entered. For example, other fields may be provided to receive information regarding the size of teams managed in prior work experience. Additionally, as shown in FIG. 12, a recruiter may select an indicator 1530 to continue entering job opening information or may select an indicator 1540 to save and continue later.

The display of FIG. 13 may be provided to allow a recruiter to provide additional information to associate with the job opening. In this example, in area 1610, a recruiter may indicate citizenships for their targeted applicant, if a work permit sponsorship is available, if a driver's license is required and/or if a credit check, criminal background check, and/or drug test is required for applying to the job opening. A recruiter may indicate via selection of an indicator 1620 that they are finished entering job opening information and that the job opening may be posted, or saved, to the job opening database 224 (FIG. 2). Upon selecting to save the job posting, the job opening controller 220 shown in FIG. 2 may save the job opening in job opening database 224, or associate the job opening with the indicated job type, desired level of competency, job hierarchy, prerequisite, organization profile, and/or any other information provided. Following saving the job opening, the job opening may be accessed by other users, such as during the specified job posting times if they are provided by the recruiter. Additionally or alternatively, any recruiter or company information provided during the job opening process may be saved to applicant profile database 232, and/or job opening database 224.

In some embodiments, upon associating the job opening with the information described above, career networking apparatus 102 may define at least one job code portion, wherein each job code portion relates to a characteristic of the job opening, and define a standardized job code comprising at least one job code portion. In some embodiments, the standardized job code may be associated with the job opening in job opening database 224. For example, with reference to FIG. 5, a job opening may be for a manager position 840 for customer service 820 of the phones division 810 for a call center. From such information, and other job characteristics, a standardized job code may be formed. For instance, with reference to FIG. 5A, if the job opening is for a position that requires management of fewer than 500 employees, but greater than 300 employees a job code portion of 500 may be used (e.g., as indicated in cell 860 of the depicted table) to indicate the number of employees the position may require management of. Additionally, in some embodiments, other job code portions can be used, as illustrated in FIG. 5B. For example, the job code portion for a call center may be 100 (e.g., shown in cell 862), the job code portion for the phones division may be 10 (e.g., shown in cell 864), the job code portion for a manager position may be 3 (e.g., shown in cell 866), and the job code portion for the job location of Atlanta may be ATL (e.g., shown in cell 868), among other various examples. The job code portions may, for example, be predefined by an administrator of the career networking apparatus 102, such as a company maintaining the servers or databases and monitoring the flow of presentation of information to users of the system. In such a way, a standardized job code can be formed that is made up of a pre-determined combination of job code portions that each represents a specific job characteristic. For example, the job code for the job opening described above may be 100-10-3-ATL. Moreover, in some embodiments, these standardized job codes may be searched, such as may enable characterization and searching across all job openings that utilize the standardized job code system.

It should be noted that the displays of FIGS. 6-13 are described with respect to creating a job opening, however, the displays may be used to modify existing job openings, recruiter information, and/or employer information, or to complete entering information for a job posting that was previously started and not completed. Displays in accordance with FIGS. 6-13 may provide additional searching and filtering of information to be associated with a job opening to facilitate data entry and/or identification of particular job postings of characteristics of such job postings.

### Locating a Job Posting for an Applicant

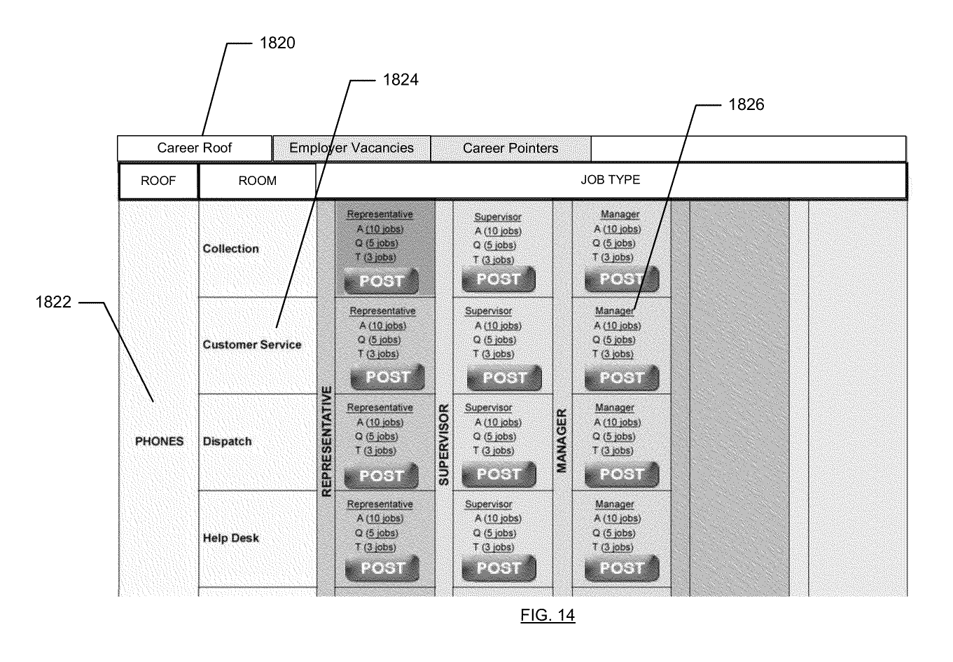

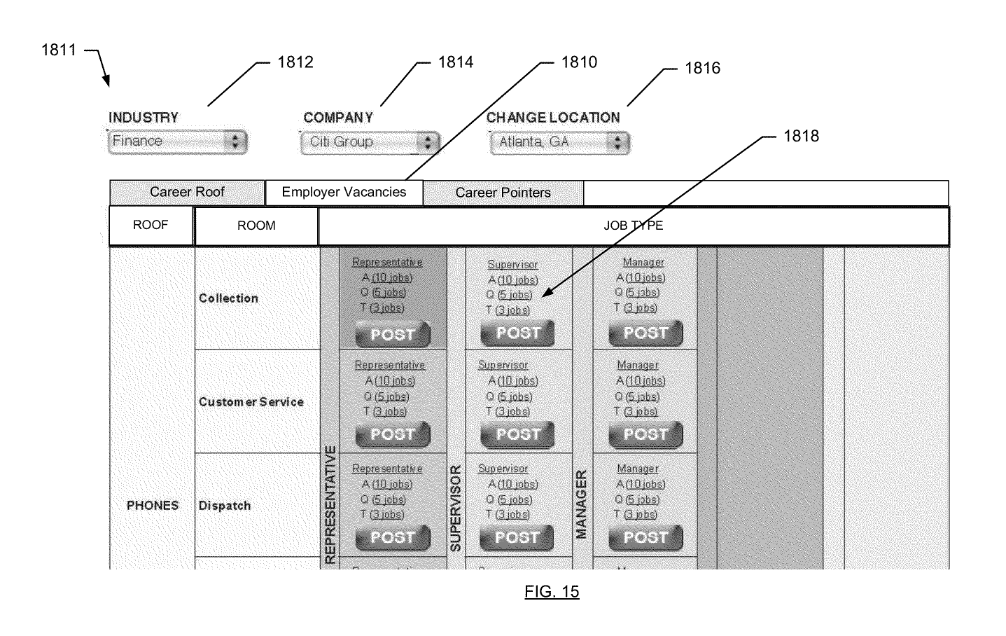

In some embodiments, career networking apparatus 102 may be configured to provide additional features (e.g., functionality), such as when displaying job postings by hierarchy. For example, with reference to the portion of the display shown in FIG. 14, a job hierarchy may be displayed so as to present job postings by career roof (e.g., Phones at area 1822), room (e.g., Customer Service at area 1824), and level (e.g., Manager at area 1826). Such a display may be presented by a user's selection of the “Career Roof” tab 1820.

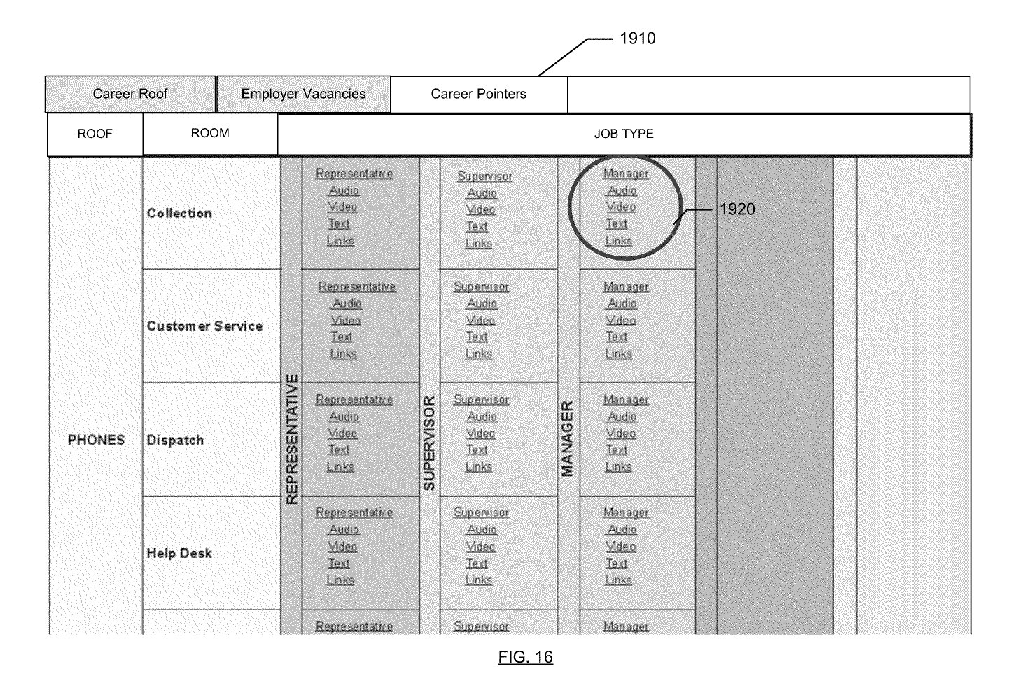

Another example of an additional feature is illustrated in FIG. 15. In some embodiments, the career networking apparatus 102 may be configured to enable a user (e.g., a person seeking employment) to filter the number of available job postings. For example, by selecting the “Employer Vacancies” tab 1810, an additional selection menu may appear, as shown in FIG. 15. In the depicted embodiment, the selection menu 1811 provides filters for Industry 1812, Company 1814, and Location 1816. Upon selection of a specific category of one or more filters (e.g., Finance for the Industry filter 1812), the job postings designated as being in the Finance Industry are represented via the number of available job postings provided (e.g., at area 1818).

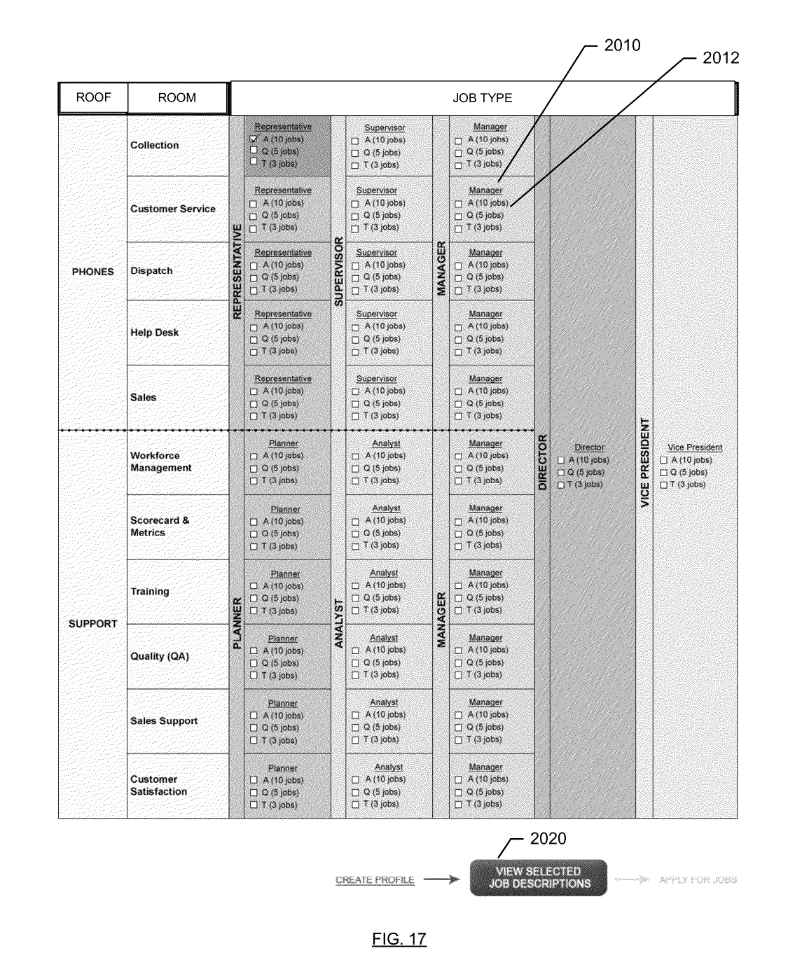

Another example of an additional feature is illustrated in FIG. 16. In some embodiments, the career networking apparatus 102 may be configured to provide links to additional information for each of the corresponding job postings. For example, a user may access career pointers or other reference information relating to a particular job type by selecting a “Career Pointers” tab 1910. In response, a display as shown in FIG. 16 may be presented in which access may be provided to information via different media formats, such as audio, video, text, or links, such as shown in area 1920.

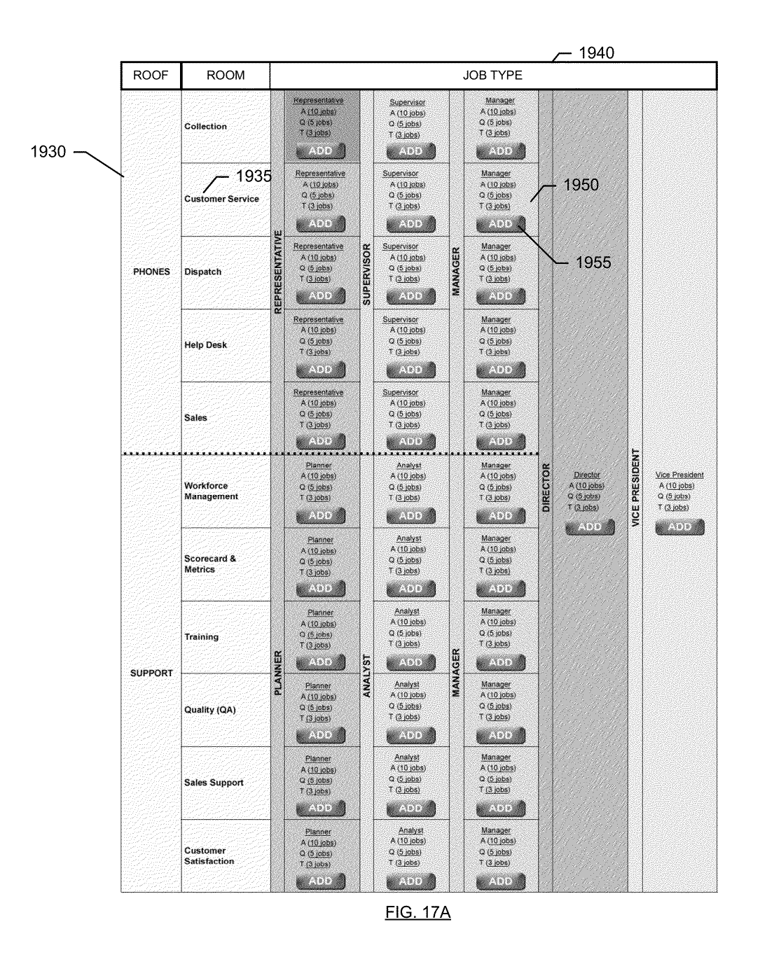

In some embodiments, the career networking apparatus 102 may be configured to find and display a job opening for an applicant. FIG. 17 illustrates an example display of a job hierarchy layout from the perspective of a job applicant, such as may be useful for finding a job posting. Example methods for displaying a job opening for a job applicant are described herein with reference to FIG. 17. As described herein, the career networking apparatus 102 may determine which job posting to display based on any number of job characteristics, such as any job characteristic that is associated with a job opening (e.g., location, company, number of employees, etc.).

In some embodiments, the career networking apparatus 102 may be configured to receive a request from an applicant to display at least one job opening associated with a job type. For example, an applicant may indicate a job type that the applicant may be interested in viewing job openings for, such as a Manager position 2010 for Customer Service of the Phones division 2010.

In some embodiments, the career networking apparatus 102 may be configured to determine an applicant level of competency for the job type. In some embodiments, the applicant level of competency for the job type comprises at least one of the following: the applicant has performed the job type before, the applicant has a skill-set used in the job type, or the applicant is able to learn the job type. Additionally, in some embodiments, the career networking apparatus 102 may be configured to gather information, such as the applicant's level of competency for the job type, from the applicant's profile, such as described in greater detail herein. Additionally, as is consistent with disclosure herein, in some embodiments, the desired level of competency comprises at least one of acquired, qualified, or targeted, where acquired relates to the desired applicant having performed the job type before; qualified relates to the desired applicant having the skill-set used in the job type; and targeted relates to the desired applicant being able to learn the job type. Thus, for example, an applicant may have the skill-set used in a manager position for customer service of the phones division of a call center because of previous employment in a similar field, but may not have served as a manager of customer service for phone calls coming into a call center. In such a situation, the applicant would be considered to be qualified for such a job opening (as opposed to acquired).

In some embodiments, the career networking apparatus 102 may be configured to perform a query to locate at least one job opening associated with the job type and a desired level of competency satisfied by the applicant level of competency. In some embodiments, the career networking apparatus 102 may be configured to query, such as through the search controller 240, the job opening database 224 to locate a job opening that is associated with the requested job type and that has a desired applicant level of competency that is satisfied by the applicant's level of competency. For example, the career networking apparatus 102 may locate any job opening for a Manager position for Customer Service within a Phones division of a call center. Then, the career networking apparatus 102 will determine which of those job openings are seeking a desired applicant having a “qualified” level of competency. In some embodiments, the career networking apparatus 102 may be configured to cause display of the at least one located job opening.

In some embodiments, the career networking apparatus 102 may be configured to determine other attributes of the applicant (e.g., certifications, qualifications, designations, etc.) or preferred job type characteristics (e.g., desired job hierarchy, preferred organization, etc.), such as may be associated with the applicant in an applicant profile (as described in greater detail herein). In such embodiments, the career networking apparatus 102 may be configured to perform the query for at least one job opening associated with the job type and any such job characteristic and/or desired attribute satisfied by the applicant's corresponding attribute. In such a manner, a specific job opening may be linked or presented to a preferred applicant. Such a feature enables easier matching of job openings to interested and properly qualified applicants.

In some embodiments, the career networking apparatus 102 may be configured to determine an additional job type. In some embodiments, the determination of the additional job type may be based at least in part on the originally selected job type. For example, certain job types may be pre-defined to be similar such that they may be recommended to an applicant. Then, the career networking apparatus 102 may be configured to cause display of the additional job type. In such a manner, the applicant may be presented with alternative career options and suggestions. Additionally, in some embodiments, the career networking apparatus 102 may be configured to determine an additional job type based on any job characteristic or applicant attribute.

While the above described example embodiment determines the appropriate level of competency of the applicant and the corresponding desired level of competency for the job opening, in some embodiments, the applicant may select to view job openings without such consideration of the applicant's level of competency. For example, in the depicted embodiment of FIG. 17, an applicant may indicate (e.g., via selection of a checkbox provided in area 2012) which competency levels they would like to view job opening details for. Then, upon subsequent selection of an indicator 2020, the job opening controller 220 and/or search controller 240 may further display information regarding the job openings to the applicant.

When searching for a job posting, an applicant may be presented with a display such as that of FIG. 17A. In this example, an applicant may have already indicated a job universe, such as call center. For example, in area 1930, the career networking apparatus 102 may provide a job roof(s) that is a part of the call center universe, such as phones or support. In area 1930, a job room, such as customer service, may be displayed that is associated with the corresponding job roof, phones. Columns such as those under job type area 1935 may provide a space for display of different job levels (e.g., representative, supervisor, manager, vice president, etc.). The job opening summary 1950 may list the number of job openings currently posted by desired level of competency, such as ‘A’ (representing acquired), ‘Q’ (representing qualified), and/or ‘T’ (representing targeted). For example, in area 1950, the job opening summary corresponding to a manager posting in customer service shows there are currently 10 job openings with a desired level of competency of acquired, 5 job openings with a desired level of competency of qualified, and 3 job openings with a desired level of competency of targeted. Additionally or alternatively, job opening summary 1950 may display a button or link 1955 (e.g., an “ADD” button) to add a job posting (or job type) to allow the applicant to view the job opening. Additionally, in some embodiments, as will be described in greater detail herein, the applicant may add the job opening or job type to a user profile (or palette). By adding the job opening or job type, the applicant may monitor that job opening or job type and, in some cases, may initiate an application for a corresponding job opening.

### Creating an Applicant Profile

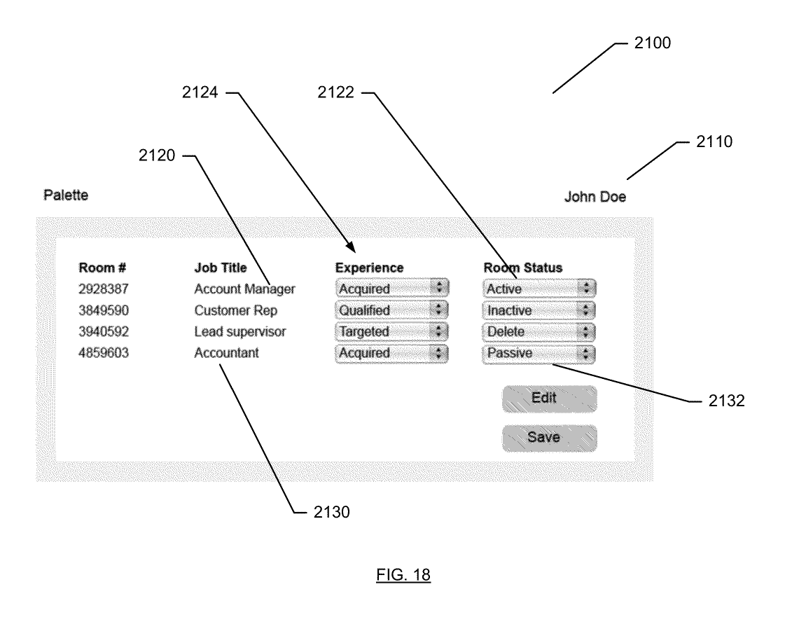

In some embodiments, the career networking apparatus 102 may be configured to create a user profile for a job applicant. For example, FIG. 18 illustrates an example display of an applicant profile 2100, which may be termed a “Palette.” The applicant profile may enable the applicant to keep updated attribute data and set preferences that may be used for job searching and career building.

In some embodiments, the career networking apparatus 102 may be configured to receive a request from an applicant to create an applicant profile. Additionally, in some embodiments, the career networking apparatus 102 may be configured to receive from the applicant at least one set of applicant data to be associated with the applicant profile. In such a regard, an applicant may input data that can be saved to the applicant profile. For example, with reference to FIG. 18, the applicant may input their name (e.g., John Doe in a name field 2110). Other information may include, for example, past job experience, current location, credentials, etc. (not shown).

In some embodiments, the career networking apparatus 102 may be configured to assign security rights to each set of data in the applicant profile such that only certain qualified individuals can view that data. As such, in some embodiments, the career networking apparatus 102 may be configured to receive an indication of a level of privacy for each set of applicant data, wherein the indication of the level of privacy comprises a selection of one of a first privacy level, a second privacy level, or a third privacy level. These levels of privacy may correspond to what degree the applicant wishes the data to be kept private. For example, the applicant may indicate that their name should be set at a first privacy level, which may enable everyone (e.g., all users, such as any recruiter, applicant, or other user accessing the system) to view the applicant's name. On the other hand, the applicant may wish to restrict access to certain data (e.g., current job title, employer, home address, among others) and may set such data at the second or third privacy level. Then, in some embodiments, the career networking apparatus 102 may be configured to associate each set of applicant data with the indicated level of privacy. For example, the applicant's name may be associated with a first privacy level, whereas applicant's home address and credentials may be set at a second privacy level. Applicant's security clearance and social security number may be set at a third privacy level.

In some embodiments, the career networking apparatus 102 may be configured to receive a request from a recruiter to display applicant data. For example, a prospective recruiter may wish to view the current job title or experience of a certain applicant. In such a situation, in some embodiments, the career networking apparatus 102 may be configured to determine a privacy clearance associated with the request. The privacy clearance may comprise one of a first clearance level, a second clearance level, and a third clearance level.

Then, based on the clearance level of the recruiter and the privacy level of the requested data, the career networking apparatus 102 may be configured to determine if the clearance level satisfies the privacy level associated with the data, and either display or, in some cases, not display the requested data. For example, in some embodiments, the career networking apparatus 102 may be configured to cause display of applicant data associated with the level of privacy satisfied by the privacy clearance, wherein the first privacy level is satisfied by the first clearance level, second clearance level, and third clearance level; wherein the second privacy level is satisfied by the second clearance level and third clearance level; and wherein the third privacy level is satisfied by the third clearance level.

In such a manner, the applicant and recruiter may engage in career networking. In some cases, the level of clearance given to the recruiter may correspond to the current stage of an interview process. Thus, in some embodiments, the career networking apparatus 102 may be configured to determine the privacy clearance by determining a job interview status associated with the request of the recruiter. The job interview status may comprise a first interview level, a second interview level, or a third interview level. Additionally, the first interview level may be associated with the first clearance level, the second interview level may be associated with the second clearance level, and the third interview level may be associated with the third clearance level. For example, the recruiter may achieve a first clearance level after receiving an initial application from a job applicant. Then, after a call back interview, the recruiter may achieve the second clearance level. Finally, after an in-person interview, the recruiter may achieve the third clearance level, which may enable them to access more private information regarding the applicant so as to help them make a final decision as to whether to offer the job to the applicant.

In some embodiments, the applicant may set at least one job seeking preference. For example, in some embodiments, the career networking apparatus 102 may be configured to receive an indication of job types that the applicant is seeking and a corresponding designation of active, passive, or inactive. An actively sought job may be a job that the applicant is actively seeking (e.g., a preferred job). A passively sought job may be a job that the applicant is willing to consider. An inactively sought job may be a job that the applicant is not willing to entertain offers for.

In some embodiments, the career networking apparatus 102 may be configured to receive an indication of an active job type list comprising job types that the applicant is actively seeking. For example, with reference to FIG. 18, the applicant in the depicted embodiment has designated the job type of Account Manager 2120 to be Active 2122. Similarly, in some embodiments, the career networking apparatus 102 may be configured to receive an indication of a passive job type list comprising job types that the applicant is passively seeking. For example, in FIG. 18, the applicant has designated the job type of Accountant 2130 to be Passive 2132. Additionally, as shown in FIG. 18, in some embodiments, the applicant may input their level of competency (e.g., acquired, qualified, targeted) for the job type (e.g., via input box 2124). Moreover, each of the job types may have a corresponding room number or other predefined code that indicates that career room for the job type (e.g., based on the hierarchy of the particular job type).

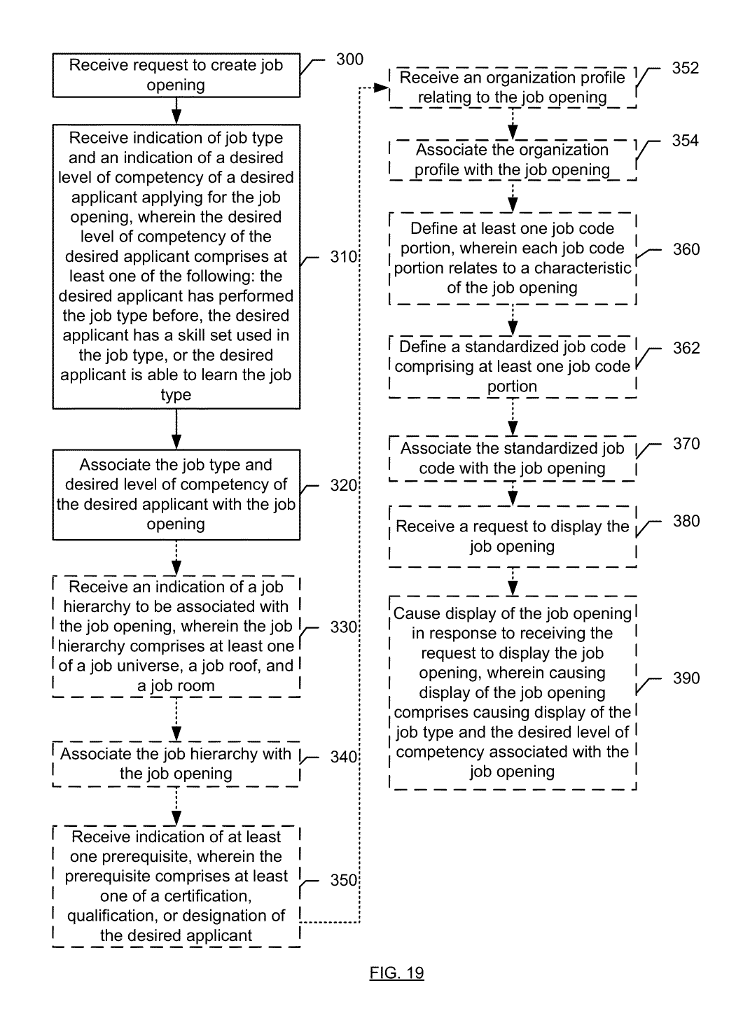

FIGS. 19, 20, and 21 are flowcharts of operations according to some embodiments. Operations illustrated in FIGS. 19, 20, and 21 may be performed by a career networking apparatus 102 and, more particularly, may be performed by, with the assistance of, and/or under the control of one or more of the processing circuitry 210, processor 212, memory 214, user interface 216, communication interface 218, job opening controller 220, profile controller 230, and/or search controller 240. For example, some operations of FIGS. 19, 20, and 21 may comprise receiving an indication, selection, or some other user input. In some embodiments such an input may be provided by a user via user terminal 110 and communicated to the career networking apparatus 102 via the communication interface 218.

FIG. 19 illustrates an example method for creating a job opening according to example embodiments described herein. Operation 300 may comprise receiving a request to create a job opening. The processor 212, user interface 216, communication interface 218, and/or job opening controller 220 may, for example, provide means for performing operation 300.

Operation 310 may comprise receiving an indication of a job type and an indication of a desired level of competency of a desired applicant applying for the job opening, wherein the desired level of competency of the desired applicant comprises at least one of the following: the desired applicant has performed the job type before, the desired applicant has a skill set used in the job type, or the desired applicant is able to learn the job type. In some embodiments, the indication of a desired level of competency may be at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type. The processor 212, user interface 216, communication interface 218, and/or job opening controller 220 may, for example, provide means for performing operation 310.

In some embodiments, operation 320 may comprise associating the job type and desired level of competency of the desired applicant with the job opening. The processor 212, user interface 216, job opening database 224, and/or job opening controller 220 may, for example, provide means for performing operation 320.

In some embodiments, operation 330 may comprise receiving an indication of a job hierarchy to be associated with the job opening, wherein the job hierarchy comprises at least one of a job universe, a job roof, and a job room. The processor 212, user interface 216, communication interface 218, and/or job opening controller 220 may, for example, provide means for performing operation 330.

In some embodiments, operation 340 may comprise associating the job hierarchy with the job opening. The processor 212, user interface 216, job opening database 224, and/or job opening controller 220 may, for example, provide means for performing operation 340.

In some embodiments, operation 350 may comprise receiving an indication of at least one prerequisite, wherein the prerequisite comprises at least one of a certification, qualification, or designation of the desired applicant. The processor 212, user interface 216, communication interface 218, and/or job opening controller 220 may, for example, provide means for performing operation 350.

In some embodiments, operation 352 may comprise receiving an indication of an organization profile relating to the job opening, such as, for example, by use of processor 212, user interface 216, communication interface 218, job opening controller 220, and/or profile controller 230. In some embodiments, operation 354 may comprise associating the organization profile with the job opening. The processor 212, user interface 216, job opening database 224, and/or job opening controller 220 may, for example, provide means for associated the organization profile with the job opening.

According to some embodiments, operation 360 may comprise defining at least one job code portion, wherein each job code portion relates to a characteristic of the job opening. The processor 212, job opening database 224, and/or job opening controller 220 may, for example, provide means for performing operation 360. In some embodiments, operation 362 may comprise defining a standardized job code comprising at least one job code portion, by for example, processor 212, job opening database 224, and/or job opening controller 220. In some embodiments, operation 370 may comprise associating the standardized job code with the job opening in job opening database 224, for example.

In some embodiments, operation 380 may comprise receiving a request to display the job opening. The processor 212, user interface 216, communication interface 218, job opening database 224, search controller 240, and/or job opening controller 220 may, for example, provide means for performing operation 380.

In some embodiments, operation 390 may comprise causing display of the job opening in response to receiving the request to display the job opening, wherein causing display of the job opening comprises causing display of the job type and the desired level of competency associated with the job opening. The processor 212, user interface 216, job opening database 224, and/or job opening controller 220 may, for example, provide means for performing operation 390.

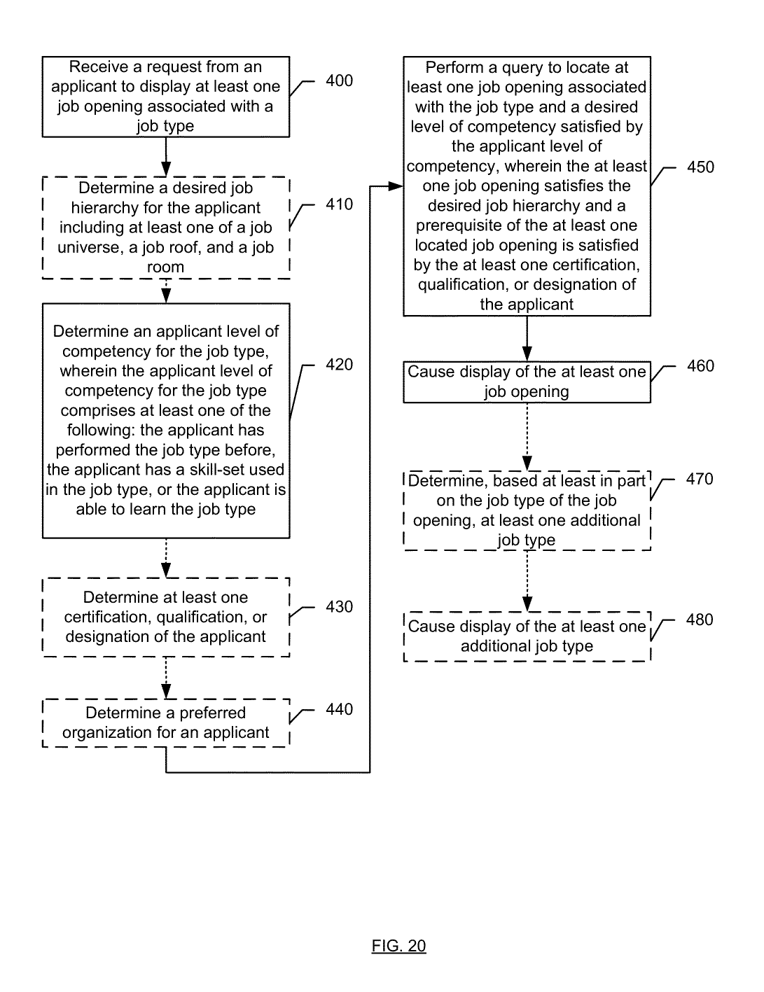

Continuing on, FIG. 20 is a flowchart illustrating a method for searching for and displaying a job opening. Operation 400 may comprise receiving a request from an applicant to display at least one job opening associated with a job type, such as, for example, by processor 212, user interface 216, communication interface 218, job opening database 224, search controller 240 and/or job opening controller 220.

In some embodiments, operation 410 may comprise determining a desired job hierarchy for the applicant including at least one of a job universe, a job roof, and a job room. The processor 212, user interface 216, applicant profile database 232, and/or profile controller 220 may, for example, provide means for determining the desired job hierarchy for the applicant.

In some embodiments, operation 420 may comprise determining an applicant level of competency for the job type, wherein the applicant level of competency for the job type comprises at least one of the following: the applicant has performed the job type before, the applicant has a skill-set used in the job type, or thee applicant is able to learn the job type. The processor 212, job opening database 224, and/or job opening controller 220 may, for example, provide means for performing operation 420.

In some embodiments, operation 430 may comprise determining at least one certification, qualification, or designation of the applicant, such as, for example, by use of processor 212, profile controller 230, and/or applicant profile database 232.

In some embodiments, operation 440 may comprise determining a preferred organization for an applicant. The processor 212, applicant profile database 232, and/or profile opening controller 230 may, for example, provide means for performing operation 440.

In some embodiments, operation 450 may comprise performing a query to locate at least one job opening associated with the job type and a desired level of competency satisfied by the applicant level of competency, wherein the at least one job opening satisfies the desired job hierarchy and a prerequisite of the at least one located job opening is satisfied by the at least one certification, qualification, or designation of the applicant. The processor 212, search controller 240, job opening controller 220, and/or job opening database 224 may, for example, provide means for performing operation 450.

According to some embodiments, operation 460 may comprise causing display of the at least one job opening. The processor 212, and/or job opening controller 220, may, for example, provide means for performing operation 460.

In some embodiments, operation 470 may comprise determining, based at least in part on the job type of the job opening, at least one additional job type. The processor 212, and/or job opening controller 220, may, for example, provide means for performing operation 460. In some embodiments, operation 480 may comprise causing display of the at least one additional job type. The processor 212, user interface 216, and/or communication interface 218, may, for example, provide means for performing operation 480.

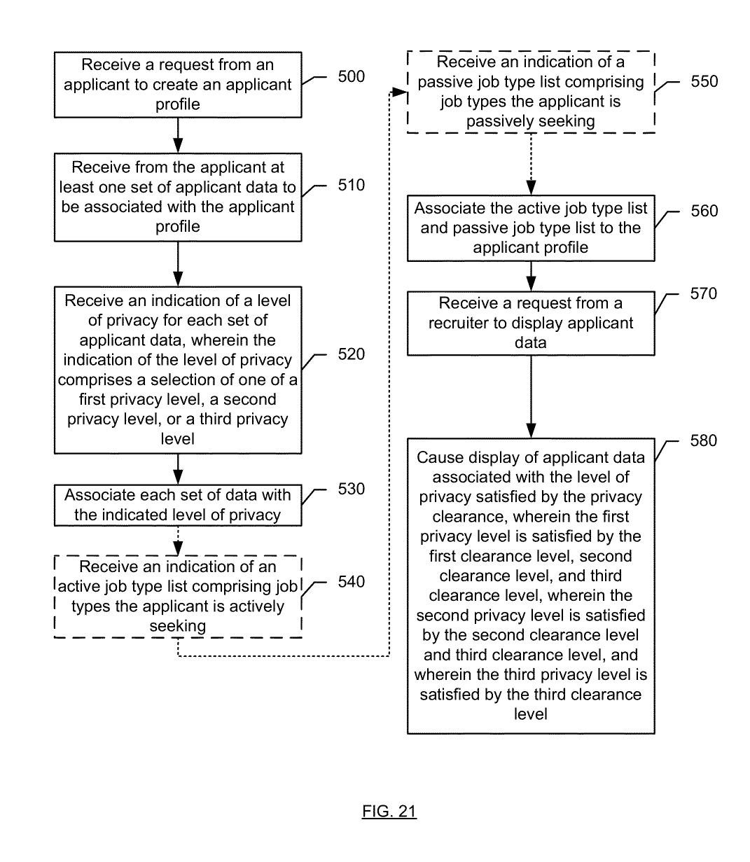

FIG. 21 is a flowchart illustrating a method for creating an applicant profile. In some embodiments, operation 500 may comprise receiving a request from an applicant to create an applicant profile. The processor 212, user interface 216, communication interface 218, and/or profile controller 230, may, for example, provide means for performing operation 500.

In some embodiments, operation 510 may comprise receiving from the applicant at least one set of applicant data to be associated with the applicant profile. The processor 212, user interface 216, communication interface 218, and/or profile controller 230 may, for example, provide means for performing operation 510.

In some embodiments, operation 520 may comprise receiving an indication of a level of privacy for each set of applicant data, wherein the indication of the level of privacy comprises a selection of one of a first privacy level, a second privacy level, or a third privacy level. The processor 212, user interface 216, communication interface 218, and/or profile controller 230, may, for example, provide means for performing operation 520.

In some embodiments, operation 530 may comprise associating each set of data with the indicated level of privacy. The processor 212, user interface 216, communication interface 218, profile controller 230, and/or applicant profile database 232, may, for example, provide means for performing operation 530.

In some embodiments, operation 540 may comprise receiving an indication of an active job type list comprising job types the applicant is actively seeking. The processor 212, user interface 216, communication interface 218, and/or profile controller 230, may, for example, provide means for performing operation 540.

In some embodiments, operation 550 may comprise receiving an indication of a passive job type list comprising job types the applicant is passively seeking. The processor 212, user interface 216, communication interface 218, and/or profile controller 230, may, for example, provide means for performing operation 550.

In some embodiments, operation 560 may comprise associating the active job type list and passive job type list to the applicant profile. The processor 212, user interface 216, communication interface 218, profile controller 230, and/or applicant profile database 232, may, for example, provide means for performing operation 560.

In some embodiments, operation 570 may comprise receiving a request from a recruiter to display applicant data. The processor 212, user interface 216, communication interface 218, and/or profile controller 230, may, for example, provide means for performing operation 570.

In some embodiments, operation 580 may comprise causing display of applicant data associated with the level of privacy satisfied by the privacy clearance, wherein the first privacy level is satisfied by the first clearance level, second clearance level, and third clearance level; wherein the second privacy level is satisfied by the second clearance level and third clearance level; and wherein the third privacy level is satisfied by the third clearance level. The processor 212, user interface 216, communication interface 218, applicant profile database 232, and/or search controller 240, may, for example, provide means for performing operation 580.

FIGS. 19, 20, and 21 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a career networking apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a career networking apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a request to create a job opening;
receiving an indication of a job type and an indication of a desired level of competency of a desired applicant applying for the job opening, wherein the desired level of competency of the desired applicant comprises at least one of the following: the desired applicant has performed the job type before, the desired applicant has a skill-set used in the job type, or the desired applicant is able to learn the job type; and
associating, by a processor, the job type and the desired level of competency of the desired applicant with the job opening.

2. The method of claim 1, wherein the indication of the desired level of competency comprises a selection of at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type.

3. The method of claim 1 further comprising:
receiving a request to display the job opening; and
causing display of the job opening in response to receiving the request to display the job opening, wherein causing display of the job opening comprises causing display of the job type and the desired level of competency associated with the job opening.

4. The method of claim 1 further comprising:
receiving an indication of a job hierarchy to be associated with the job opening, wherein the job hierarchy comprises at least one of a job universe, a job roof, or a job room; and
associating the job hierarchy with the job opening.

5. The method of claim 1 further comprising:
defining at least one job code portion, wherein each job code portion relates to a characteristic of the job opening;
defining a standardized job code comprising at least one job code portion; and
associating the standardized job code with the job opening.

6. The method of claim 1 further comprising:
receiving an indication of at least one prerequisite relating to the job opening, wherein the at least one prerequisite comprises at least one of a certification, qualification, or designation of the desired applicant; and
associating the at least one prerequisite with the job opening.

7. The method of claim 1 further comprising:
receiving an organization profile relating to the job opening; and
associating the organization profile with the job opening.

8. Computer program product comprising a non-transitory computer readable medium having program code portions means stored thereon, the program code portions being a computer readable medium and configured when said program product is run on a computer or network device, to:
receive a request to create a job opening;
receive an indication of a job type and an indication of a desired level of competency of a desired applicant applying for the job opening, wherein the desired level of competency of the desired applicant comprises at least one of the following: the desired applicant has performed the job type before, the desired applicant has a skill-set used in the job type, or the desired applicant is able to learn the job type; and
associate the job type and the desired level of competency of the desired applicant with the job opening.

9. The computer program product of claim 8, wherein the indication of the desired level of competency comprises a selection of at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type.

10. A method comprising:
receiving a request from an applicant to display at least one job opening associated with a job type;
determining, by a processor, an applicant level of competency for the job type, wherein the applicant level of competency for the job type comprises at least one of the following: the applicant has performed the job type before, the applicant has a skill-set used in the job type, or the applicant is able to learn the job type;
performing a query to locate at least one job opening associated with the job type and a desired level of competency satisfied by the applicant level of competency; and
causing display of the at least one located job opening.

11. The method of claim 10, wherein the desired level of competency comprises at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type.

12. The method of claim 10, further comprising:
determining a desired job hierarchy for the applicant including at least one of a job universe, a job roof, or a job room; and
wherein the at least one job opening satisfies the desired job hierarchy.

13. The method of claim 10, further comprising:
determining at least one certification, qualification, or designation of the applicant,
wherein a prerequisite of the at least one located job opening is satisfied by the at least one certification, qualification, or designation of the applicant.

14. The method of claim 10, further comprising:
determining a preferred organization for an applicant; and
wherein the preferred organization for the applicant is satisfied by an organization associated with the at least one located job.

15. The method of claim 10, further comprising:
determining, based at least in part on the job type of the job opening, at least one additional job type; and
causing display of the at least one additional job type.

16. Computer program product comprising a non-transitory computer readable medium having program code portions means stored thereon, the program code portions being a computer readable medium and configured when said program product is run on a computer or network device, to:
receive a request from an applicant to display at least one job opening associated with a job type;
determine an applicant level of competency for the job type, wherein the applicant level of competency for the job type comprises at least one of the following: the applicant has performed the job type before, the applicant has a skill-set used in the job type, or the applicant is able to learn the job type;
query job openings to locate at least one job opening associated with the job type, wherein the applicant level of competency satisfies a desired level of competency associated with the job opening; and
cause display of the at least one located job opening.

17. The computer program product of claim 16, wherein the desired level of competency comprises at least one of acquired, qualified, or targeted, wherein acquired relates to the desired applicant having performed the job type before, wherein qualified relates to the desired applicant having the skill-set used in the job type, and wherein targeted relates to the desired applicant being able to learn the job type.

18. A method comprising:
receiving a request from an applicant to create an applicant profile;
receiving from the applicant at least one set of applicant data to be associated with the applicant profile;
receiving an indication of a level of privacy for each set of applicant data, wherein the indication of the level of privacy comprises a selection of one of a first privacy level, a second privacy level, or a third privacy level;
associating, by a processor, each set of applicant data with the indicated level of privacy;
receiving a request from a recruiter to display applicant data;
determining a privacy clearance associated with the request, wherein the privacy clearance comprises one of a first clearance level, a second clearance level, or a third clearance level; and
causing display of applicant data associated with the level of privacy satisfied by the privacy clearance, wherein the first privacy level is satisfied by the first clearance level, second clearance level, and third clearance level, wherein the second privacy level is satisfied by the second clearance level and third clearance level, and wherein the third privacy level is satisfied by the third clearance level.

19. The method of claim 18, wherein determining the privacy clearance comprises determining a job interview status associated with the request of the recruiter, wherein the job interview status comprises one of a first interview level, a second interview level, or a third interview level, and wherein the first interview level is associated with the first clearance level, the second interview level is associated with the second clearance level, and the third interview level is associated with the third clearance level.

20. The method of claim 18, further comprising:
receiving an indication of an active job type list comprising job types the applicant is actively seeking;
receiving an indication of a passive job type list comprising job types the applicant is passively seeking; and
associating the active job type list and passive job type list to the applicant profile.
